(19) United States
(12) Patent Application Publication
(10) Pub. No.: US 2001/0055486 A1
(43) Pub. Date: Dec. 27, 2001

(54) Support device for cameras and the like

(76) Inventor: Noorali G. Visram, Nr Welwyn (GB)

Correspondence Address: Sean M. Casey Co., L.P.A., Attention: Sean M. Casey, P.O. Box 710, New Albany, OH, 43054-0710, US

(21) Appl. No.: 09/883,004

(22) Filed: Jun. 15, 2001

(30) Foreign Application Priority Data
Dec. 17, 1998 (GB) 9827646.2
Dec. 13, 1999 (IB) PCT/IB99/01996

(51) Int. Cl. G03B 17/00

(52) U.S. Cl. 396/419

(57) ABSTRACT

A support device for cameras and like articles that comprises a base member (10), mounting means (11, 64) for support means (16) removably carried by the base member for mounting of a camera or like article thereon, and a plurality of support legs (32), which are detachably mountable to the base member (10) to project therefrom in a plurality of different selected orientations relative to the base member and to provide selected support functions. The support legs (32), when not performing the support function, may be housed in bores (38) in the base member (10).

This patent is a U.S. national application of PCT international application no. PCT/IB99/01996, filed Dec. 13, 1999, which claims the right of priority to and benefit of the earlier filing date of Great Britain application serial no. 9827646.2, filed Dec. 17, 1998.

### BACKGROUND OF THE INVENTION

1. Field of the Invention

This invention relates to support devices for portable apparatus such as cameras, microphones, telescopes, surveying equipment and the like.

2. Description of the Related Art

Many devices are known for the mounting of cameras and like articles on flat surfaces, windows, railings, etc. However, the devices are generally bulky and complex and have limited mounting capabilities.

U.S. Pat. No. 5,055,864 describes a portable camera support comprising a bracket which is intended to provide a stable platform for a camera in window openings, for example of a motor vehicle. However, this bracket would not be appropriate for mounting a camera on a flat surface or on a curved surface such as a railing. U.S. Pat. No. 4,439,032 describes a portable camera support which utilizes a strap which passes around a railing or tree and which is intended to mount a camera firmly thereon.

International Publication no. WO-A-98/39178 describes a pedestal for stable support of a variety of equipment, for example a camera, and which comprises two limbs which can be used to either stand the support on a surface e.g. a table, or hang the support from a vertical member, e.g. a vehicle window. It is however extremely bulky.

Great Britain Patent No. 2,272,834 describes a camera support that is more versatile in terms of how it can be used, but it is relatively complex in terms of the large number of parts. It is essentially a tripod that is separable to offer greater possibilities for the support to be mounted elsewhere than on flat surfaces.

U.S. Pat. No. 3,908,945 is directed to a portable camera mounting apparatus having a hollow telescopic body structure for supporting a camera. The body structure includes, among other features, support legs that can be detachably mounted to the body structure. This device is limited to support articles on a substantially horizontal surface, such as a table, floor, or the ground.

It is therefore an object of the present invention to provide a support for cameras and like articles which is extremely versatile in terms of its mounting and supporting capabilities, yet which is extremely compact and composed of relatively few components.

### SUMMARY OF THE INVENTION

In accordance with the present invention there is provided a support device for cameras and like articles which comprises a base member, at least one mounting means for support means removably carried by the base member for mounting of a camera or like article thereon, and a plurality of support legs detachably mounted to the base member to project therefrom in a plurality of different selected orientations relative to the base member. The various orientations may be selected to establish a plurality of different selected support functions and orientations for the support device, whereby a support device that is versatile in use is obtained.

Preferably the support legs are securable to the base member through screw-threaded members with the respective female members being formed in the base member, preferably threaded holes whose axes are orientated along a plurality of different directions, preferably in at least three orthogonal directions.

The support legs when not performing the support function may be carried in bores in the base member in a non-functional position. The bores add rigidity to the base member and reduce the weight thereof. Preferably the legs are retained in the bores by being screwed into threaded portions of said bores. Preferably, four support legs are provided with the base member each being housed in a respective bore.

The base member is preferably provided with a recess in its underside, and with slots there through, to enable the base member to be secured by tie means passed through the slots to an elongate supporting member, such as a rail, a pole, a post or the limb of a tree, which is positioned in the recess. The recess may have a substantially ‘V’ shaped or generally arcuate cross-section and its surface may be provided with a non-slip surface by, for example, being ribbed or knurled.

These variations, modifications, and alterations of the various preferred embodiments and methods may be used either alone or in combination with one another as will become more readily apparent to those with skill in the art with reference to the following detailed description of the preferred embodiments and the accompanying figures and drawings.

### BRIEF DESCRIPTION OF DRAWINGS

In order that the invention may be more fully understood, one presently preferred embodiment of camera support in accordance with the invention will now be described by way of example and with reference to the accompanying drawings in which:

FIG. 1 is a schematic plan view of the support device;

FIG. 2 is a schematic view from one end of the support device shown in FIG. 1 taken in the direction of the arrow denoted by reference numeral II in FIG. 1, with the support legs removed;

FIG. 3 is a schematic view of the support device, taken from the other end and in the direction indicated by the arrow denoted by reference numeral III in FIG. 1, with the support legs removed;

FIG. 4 shows one of the support legs of the device; and

FIG. 5 is a side view of the body member taken in the direction of arrow denoted by reference numeral V in FIG. 1.

### DETAILED DESCRIPTION OF THE INVENTION

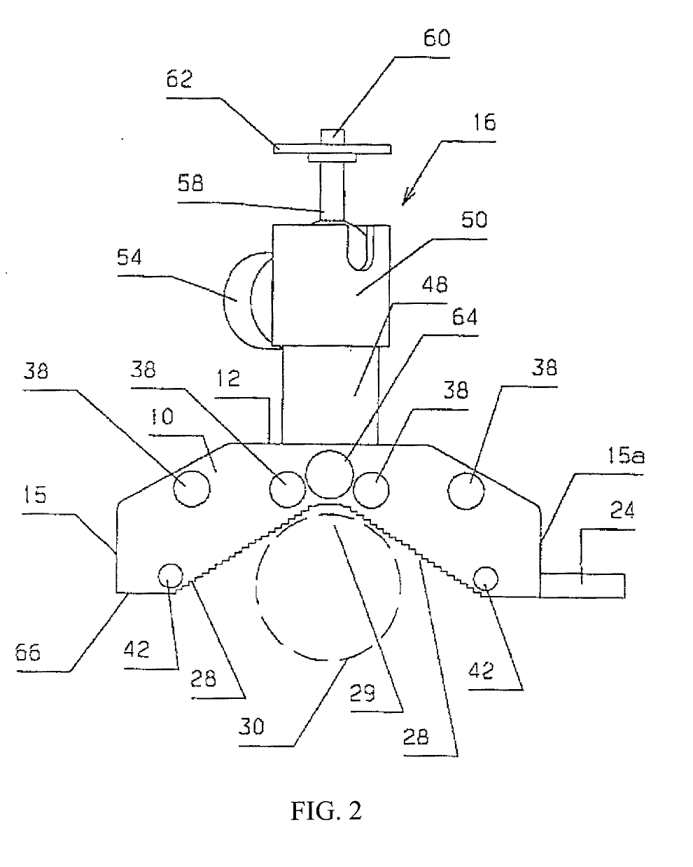

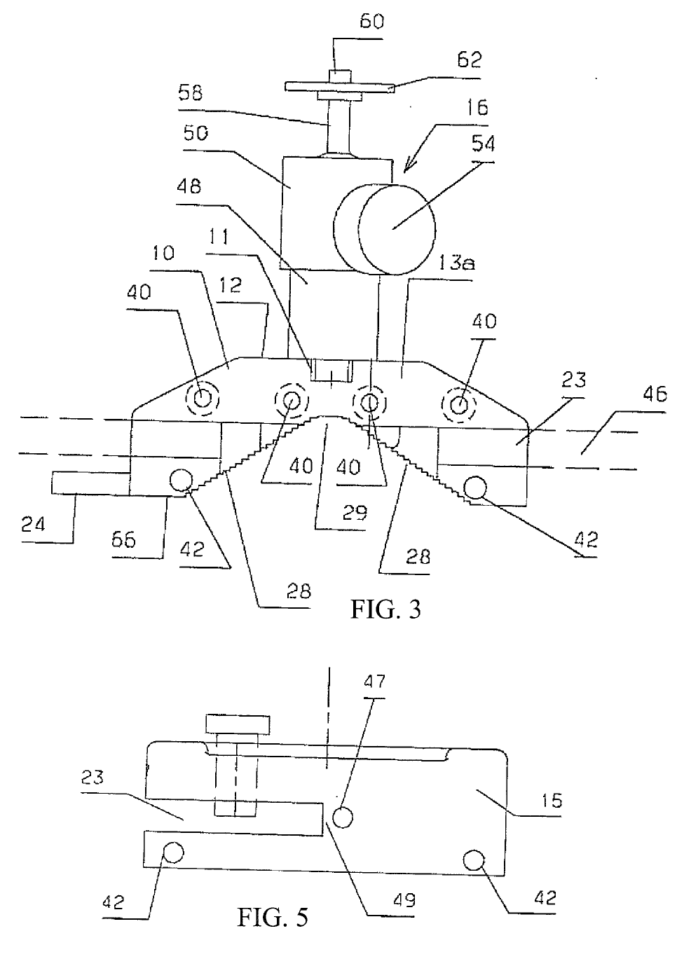

According to the present invention, a support device is shown in the drawings that may be used with cameras or other optical equipment. The device has a base member 10 made from any suitable material such as engineering plastics material such as polyamide, acetal resin, thermoplastic polyester or a metal such as aluminum or die cast zinc. The base is shaped somewhat in the manner of a bridge, as can be seen most clearly from FIGS. 2 and 3. The base member 10 has a top portion 12 with end walls 13, 13a and side portions 15, 15a. The top portion 12 is provided with a threaded hole 11 (FIG. 3) forming a mounting means for a like screw-threaded stud shaft of a removable support-and-tilt assembly 16 and which will be described in more detail hereinafter.

The top portion 12 of the base member is provided with a pair of parallel slots 18 which extend in the longitudinal direction almost the full length of and through the thickness of the base member.

One side portion 15a has an outwardly projecting integral lug 24 with a keyhole-shaped hole 26 there through. The lug 24 enables the support device to be hung by lug 24 from a wall fixing e.g. a screw, nail or pin.

As shown most clearly in FIGS. 2 and 3, the underside 66 of the base member is provided with a substantially ‘V’ shaped or generally arcuate recess 29. The recess 29 comprises two ribbed surfaces 28 inclined at about 120 degrees or arc to each other. The ribbed surfaces provide grip to enable the support device to be mounted on an elongate supporting member such as a rail, a pole, a post or the limb of a tree, as indicated in broken outline at 30 in FIG. 2. The support device would be fixed to the supporting member 30 by the use of a flexible strap or tie (not shown) which is threaded through the slots 18 in the base member and around the supporting member 30. It will be appreciated that with this configuration, supporting members 30 of a wide variety of thicknesses can be accommodated and have the support device held stably or firmly thereto.

An important feature of the invention is the provision of four support legs 32, one of which is shown in FIG. 4. Each support leg 32 comprises an elongate stem with a threaded stub 34 at one end. Two resilient rings 36, for example of rubber or plastics material, are recessed into the stem at spaced intervals along the length of the support leg so to provide a resilient surface which is slightly proud of the surface of the leg. The support legs 32 are normally housed within bores 38 formed in the base member 10, when the support device is not in use. The bores 38 extend from one end wall 13 to the other end wall 13a through the main body of the base member. These bores 38 terminate at said other end of the base member, as shown in FIG. 3, in reduced diameter screw-threaded portions or holes 40. When not in use, the support legs 32 are pushed into the bores 38 (FIG. 2) and have their threaded ends 34 screwed into the threaded holes 40. The legs 32 may have any desired length but preferably leave only a short portion of the plain end of the support leg 32 projecting from the end of the base member. The non-threaded end portion of the legs 32 may be knurled to facilitate the screwing and unscrewing of the legs.

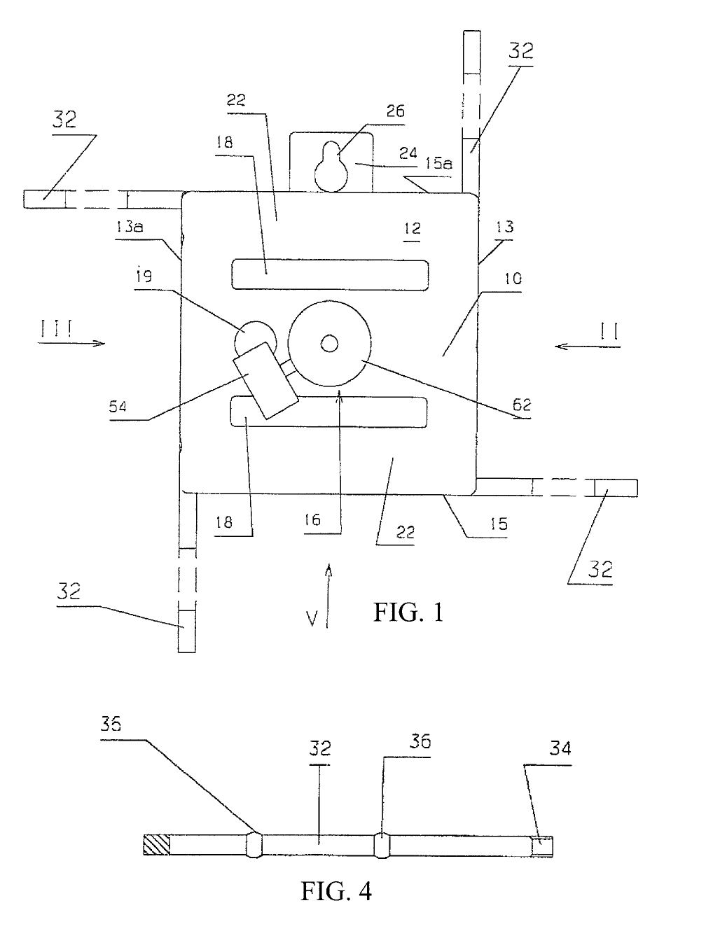

The support legs 32 play a key role in the use of the support device. They have a number of different applications, depending upon need. Each corner of the base member 10 is provided with two screw-threaded holes 42 (FIGS. 2 and 3) adjacent to the bottom of the base member. Each of these screw-threaded holes 42 is dimensioned to receive a threaded stub end 34 of a support leg 32. Thus, as shown in FIG. 1, the support legs 32 can be screwed into the corners of the base member 10 to extend in four directions at right-angles to each other and thus provide a stable support for the support device, preventing it from tilting in any direction. Alternatively, if needed, the support legs 32 can be screwed into the holes 42 in opposite ends 13, 13a, or in opposite sides 15, 15a of the base member in order to provide greater stability in one direction than in the normal direction. The individual support legs 32 can be used, as necessary, to meet the individual circumstances. Because the holes 42 are adjacent to the bottom of the base member, the support legs 32, when screwed into place, have their undersides flush with the flat surface on which the base member is positioned. This prevents any wobbling of the unit.

The support device of the present invention also permits the unit to be mounted stably on for example the window of a motor vehicle, or indeed on any generally upright plate-like member. As described above, the other end 13a of the base member 10, shown in FIG. 3, is provided with a plurality of screw-threaded holes 40, which are each dimensioned to receive the threaded stub end 34 of the support legs 32. When screwed into place in these holes 40 and in holes 42, the support legs may define a channel. Such a channel may for example receive the glass of a vehicle window, as indicated schematically at 46 in FIG. 3. As shown, two of the support legs would be positioned on one side of the glass and the other two on the other side, thereby holding the assembly stably on the glass. The resilient annular members 36 on each support leg 32 make contact with the surfaces of the glass and assist in holding the unit securely in place without wobbling.

In addition to providing the threaded holes 40, 42 to receive the support legs 32, the end wall 13A of the base member can be provided with a slot 23, as shown in FIG. 3, which extends substantially along the line of the glass indicated at 46 in FIG. 3. Such a slot could open into the slots 18 and thereby extend over a substantial part of the end-to-end dimensions of the base member, i.e. into the plane of the drawing as shown in FIG. 3. The base member 10 would then form a caliper type support and the slot 23 would then receive the window glass or the like, with the legs of the caliper lying each side of the glass and a bridge portion 49 straddling the edge of the window. The slots could be faced with a rubber or plastic material for protection purposes and to prevent vibration. The top portion 12 of the base member may be provided with a screw-threaded bore 19 (FIG. 1) which receives a thumb wheel type clamping screw (not shown) for clamping the body directly to the glass. The clamping screw may have a resilient tip where it engages the glass in order to minimize damage to the clamped surface. Additionally, the base member may be provided with further threaded holes 47 located in the side portions in the bridge portion 49 so that the legs 32 may be positioned to extend parallel to the edge of the window and prevent rocking of the support device in the plane of the glass.

The support-and-tilt assembly 16 is particularly adapted for the mounting of a camera on the support device. A screw-threaded stub at the bottom of the unit extends from a generally cylindrical rod 48 that has a concentric annular collar 50. The upper end of the collar 50 houses a ball from which a shaft 58 extends upwards, terminating in a threaded end 60 onto which is screwed a cap 62. The ball joint that is thereby achieved enables a camera screwed onto the threaded end 60 to be adjusted in position.

If further height is required for the support device, then the support-and-tilt assembly 16 can be unscrewed from the base member and an extension member can be fitted between the base member and the support-and-tilt assembly 16. The base member 10 is also provided in said one end wall 13 with a further threaded hole 64 (FIG. 2) into which the support-and-tilt assembly can be fitted as an alternative position, particularly when the device is used as in FIG. 3 for mounting a camera on a window glass, or vertical support such as a rail, a pole, a post or the limb of a tree. Then, the support legs 32 extend downwards, over the glass, and the support-and-tilt assembly extends upwards, facilitating its use.

In a further embodiment of the support device, the underside of the base member, indicated at 66 in FIGS. 2 and 3, is provided with threaded holes adjacent the corners (not shown) having axes normal to the holes 42 and dimensioned to receive the threaded ends 34 of the support legs 32. This enables the device to be mounted on an object which is located between the support legs 32, with the support-and-tilt assembly 16 set in the top surface 12 of the base member, as shown in the drawings. A plurality of spaced holes may be provided to accommodate different sizes of supporting member.

In another variation a plurality of spaced screw-threaded holes for the legs 32 may be provided in the surface 28 of the recess 29. These holes may be spaced apart irregularly and have axes inclined at different angles to the surface 28 allowing legs 32 to be screwed at various inclinations into the base member 10 at variable spaced locations so that the legs may act as clamps against smaller diameter articles or elongate supporting members 30. The screw-threaded portions 34 of the legs 32 may have increased lengths to facilitate this function.

The support device provides a compact unit which, when in a disassembled condition, with the legs housed in the bores 38, can be carried in the pocket of the user, and which can be assembled to provide different constructions having different end uses.

Although the exemplary embodiments of the present invention have been described in detail above, numerous alterations, modifications, and variations of the preferred embodiments disclosed herein will be apparent to those skilled in the art and they are all contemplated to be within the spirit and scope of the instant invention. For example, although specific embodiments, modifications, variations, and examples have been described in detail, those with skill in the art will understand that such can be modified to incorporate various types of substitute and/or additional materials, components, elements, and relative arrangement thereof for compatibility with the wide variety of contemplated uses and equipment available and in use in the related industries. Accordingly, even though only few variations, modifications, and examples of the present invention are described herein, it is to be understood that the practice of such additional modifications and variations and the equivalents thereof, are within the spirit and scope of the invention as defined in the following claims.

What is claimed is:

1. A support device for supporting cameras, microphones, telescopes, surveying equipment, and like articles on a variety of supporting surfaces and members including windows, tables, the ground, poles, tree limbs, rails, posts, and any of a number of regular and irregular supporting surfaces and members, comprising:
a base member;
a mounting means adapted with support means and removably carried by the base member and further adapted to mount an article selected from the group including a camera and devices similar thereto;
a plurality of support legs detachably mountable by mountings to the base member to project therefrom in a plurality of different orientations relative to the base member; and
wherein the support leg mountings are adapted to be oriented in respective positions relative to the base member in a plurality of different selected directions and orientations for compatibility with a support surface selected to establish a plurality of support configurations.

2. A support device according to claim 1, wherein the support legs are secured to the base member by screw-threaded members with the respective female members being carried on the base member.

3. A support device according to claim 2, wherein the female members are threaded holes formed in the base member to have respective axes that are orientated in a plurality of different directions.

4. A support device according to claim 2, wherein at least 3 of the female members are adapted to have respective axes orientated in at least three orthogonal directions.

5. A support device according to claim 2, wherein the base member is formed with bores adapted to receive and store at least one of the plurality of support legs when they are not mounted in the support configuration.

6. A support device according to claim 5, wherein the bores and support legs are each formed with threaded portions adapted whereby the support legs may be threaded into and retained within the bores.

7. A support device according to claim 2, wherein the base member is formed on its underside to have a recess having a shape selected from the group including a substantially ‘V’ shape and a substantially arcuate shape, the recess configured whereby the base member is supportable against at least one of the supporting surfaces.

8. A support device as according to claim 7, wherein the recess is formed with a surface that is textured with a feature selected from the group including ribs and knurls.

9. A support device according to claim 2, wherein the base member is arranged to be supported directly against by the supporting member, and wherein the base member is formed to have through slots that are sized and shaped to receive tie means passed through the slots and around the supporting member to thereby secure the base thereto.

10. A support device according to claim 2, wherein the base member is formed with a through slot formed to receive a substantially flat plate-like support, and wherein the base member is further formed with portions adapted to be located on each side of the plate-like support.

11. A support device according to claim 2, wherein the base member is formed with threaded holes positioned in the base member and oriented whereby the support legs pass about each side of a plate-like support surface.

12. A support device according to claim 2, wherein the base member is formed with additional threaded holes located in side portions of the base member, the holes being configured whereby the support legs can be positioned to extend substantially parallel to the edge of a plate-like support to prevent rocking of the support device in the plane of the plate-like support.

13. A support device according to claim 2, wherein the base member is formed on its underside to have a recess having a shape selected from the group including a substantially ‘V’ shape and a substantially arcuate shape, the recess configured whereby the base member is supportable against at least one of the supporting surfaces, and wherein the recess has a surface that is further formed with a plurality of spaced apart threaded holes having respective axes inclined at different angles to the surface, the holes being adapted to secure the supporting legs to at various orientations relative to the base member.

14. A support device according to claim 13, wherein the support legs can be secured to the base to have a configuration operative to clamp to supporting members.
